(19) United States
(12) Patent Application Publication
(10) Pub. No.: US 2011/0154553 A1
(43) Pub. Date: Jun. 30, 2011

(54) FLAME RESISTANT UNDERGARMENTS

(75) Inventor: Marie Thompson, Albemarle, NC (US)

(73) Assignee: Longworth Industries, Inc., West End, NC (US)

(21) Appl. No.: 12/649,889

(22) Filed: Dec. 30, 2009

(51) Int. Cl. A41B 9/00; A41B 9/06; A62B 17/00

(52) U.S. Cl. 2/78.1; 2/400; 2/113; 2/81

(57) ABSTRACT

An aspect of the invention is a flame resistant, durable, pill resistant undergarment. The undergarments are formed of a first knitted portion. The first knit portion is a well knit structure formed from air-jet spun yarns formed from an intimate blend of about 72 percent to about 80 percent modacrylic fibers and about 20 percent to about 28 percent cotton fibers. The linear density of the air-jet yarns are between about 30/1 cc and about 36/1 cc.

### FIELD OF THE INVENTION

The present invention relates generally to apparel products, and more particularly, to flame resistant undergarments such as undershirts, short underwear and long underwear.

### BACKGROUND OF THE INVENTION

“Base layer” apparel conventionally refers to garments that are worn against the skin, often as undergarments such as underwear and T-shirts, beneath outerwear such as trousers, shirts/blouses, skirts, etc. Such garments are formed to have a soft touch, or hand, and among other things, provide support against the skin, and serve to absorb perspiration during normal daily activities.

Unfortunately, however, base layer garments formed of conventional yarns and fabrics are not adequate for flame resistance. While fabrics for use in hazardous conditions may be chemically treated to afford some flame resistance, such chemical treatments degrade over the life of the garment through physical wear and laundering. Poor flame resistance is therefore unsatisfactory for base layer apparel for military personnel that subject these garments to extreme wear conditions.

While some inherently flame-resistant yarns and fibers are now known for use in manufacturing apparel, these materials alone provide an unsatisfactory degree of comfort and durability when formed into base layer apparel worn adjacent the skin. Most of these synthetic flame resistant materials also are generally hydrophobic. For example, these materials lack an affinity to water-based chemical treatments, and will not absorb moisture and/or body perspiration during wear. Such materials also may be costly while not meeting all of the attributes required of high performance apparel.

### SUMMARY OF THE INVENTION

The inventors recognized the need for an undergarment that provides not only adequate, long-term, flame resistance, but that also is durable, pill resistant, moisture absorbent, and has a soft hand that is comfortable to the wearer for extended periods under conditions such as high temperature and high humidity.

An aspect of the invention is a flame resistant, durable, pill resistant, upper body undergarment that is also moisture absorbent and has a soft hand that is comfortable to the wearer. The upper body undergarment, e.g., an undershirt, includes an upper torso portion formed substantially of a first knitted portion, two arm openings and a neck opening that has a peripheral edge. The first knitted portion is a weft knit structure formed from air-jet spun yarns formed from an intimate blend of about 72 percent to about 80 percent modacrylic fibers and about 20 percent to about 28 percent cotton fibers. The linear density of the air-jet yarns are between about 30/1 cc and about 36/1 cc. The peripheral edges form a hem around the arm and neck openings.

Another embodiment of the invention is a flame resistant, pill resistant, durable, lower body undergarment, such as long or short underwear, that is also moisture absorbent and has a soft hand that is comfortable to the wearer. The lower body undergarment includes a legs and a lower torso portion formed substantially of a first knitted portion, a waist opening and two leg openings. As described above, the first knitted portion has a weft knit structure formed from air-jet spun yarns that comprise an intimate blend of about 72 percent to about 80 percent modacrylic fibers, and between about 20 percent and about 28 percent cotton fibers. The linear density of the air-jet spun yarns are between 30/1 cc and 36/1 cc. The waist and leg openings also have a peripheral edge, such as a hem.

The undergarments further include various chemical treatments that may be applied to the fabric during dyeing and/or finishing. Exemplary chemical treatments include a wicking agent, a softener, and an antimicrobial agent, which may be applied during or after dyeing. The wicking agent facilitates the movement of moisture through the undergarment. Softeners may be applied to improve hand, while not compromising other attributes, such as colorfastness, and the like. An anti-microbial treatment also may be applied, and are effective after multiple launderings and use, and have been shown to inhibit or prevent the growth of micro-organisms.

The embodiments described above are exemplary only, and other aspects of the present invention will become apparent to those skilled in the art after a reading of the following description of the preferred embodiment in combination with the figures.

### BRIEF DESCRIPTION OF THE DRAWINGS

FIG. 1 is a plan view of an embodiment of a flame-resistant undergarment.

FIG. 2 is a plan view of another embodiment of a flame-resistant undergarment.

### DESCRIPTION OF THE PREFERRED EMBODIMENT

Certain exemplary embodiments of the present invention are described below and illustrated in the accompanying figures. The embodiments described are only for purposes of illustrating the present invention and should not be interpreted as limiting the scope of the invention, which, of course, is limited only by the claims below. Other embodiments of the invention, and certain modifications and improvements of the described embodiments, will occur to those skilled in the art and all such alternate embodiments, modifications, and improvements are within the scope of the present invention.

The flame resistant undergarments of this invention are worn as base-layer apparel, or next-to-skin apparel. The undergarments include, but are not necessarily limited to, long or short-sleeve undershirt, and long or short underwear, tank tops, full body undergarments, and other similar next-to-skin undergarments. These undergarments surprisingly have improved visual aesthetics, and a soft hand that is comfortable to the wearer for extended periods, and for repeated uses, under conditions such as high temperature and high humidity.

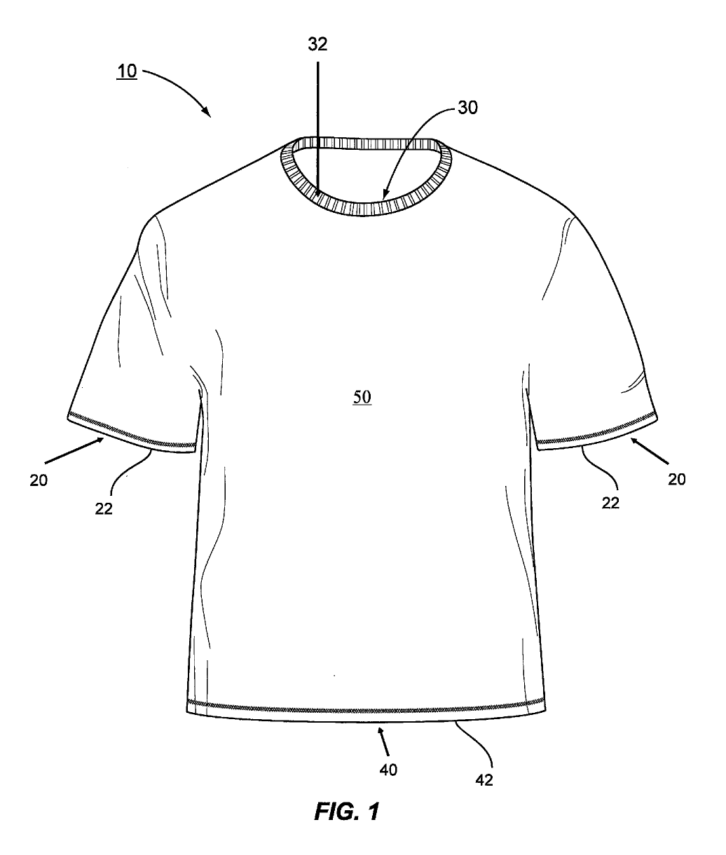

As shown in FIG. 1, an embodiment of the invention is an undershirt 10 including the upper torso portion 50, two arm openings 20, a neck opening 30 and large body opening 40. The arm, neck and body openings include peripheral edges 22, 32, 42, respectively. The undershirt 10 is substantially formed of a first knitted portion that includes a flame resistant weft knit fabric comprising yarns that are an intimate blend of a flame-resistant fiber, in particular modacrylic, and at least a second fiber, such as cotton. The peripheral edges (22, 32, and 42) of the arm, neck and body openings have a hem that is formed from either a first knitted portion, or a second knitted portion. For example, the hem may be the first knitted portion with the edge folded over and sewn, or the hem may be a second knitted portion, e.g. a separately rib-knitted fabric that is sewn onto the arm or neck openings.

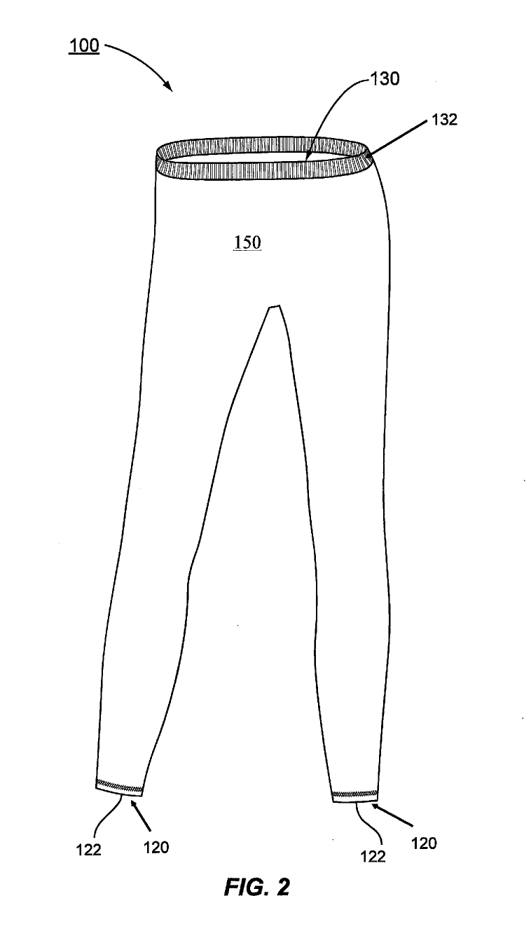

As shown in FIG. 2, an embodiment of the invention is also a long underwear garment 110 with a lower torso portion 150, leg openings 120, and a waist opening 130. The leg and waist openings 120 and 130 include peripheral edges 122 and 132, respectively. The underwear 110 is substantially formed of the first knitted portion described above. The peripheral edges (122, 132) of the leg and waist openings (120 and 130) have a hem that is also formed of either the first or second knitted portion as described above.

The first knitted portion is preferably a single jersey fabric. An exemplary single jersey fabric preferably has between about 30 courses per inch (cpi) and about 90 cpi. The wales per inch (wpi) range between about 20 wpi and about 60 wpi. In an embodiment, the course count is about 62 cpi and the wale count is about 32 wpi. The course and wale counts, however, are not limited to the values, or the ranges described above. The knitted portion has a finished fabric weight between about 4.0 oz/yd² (135 g/m²) and about 6.0 oz/yd² (203 g/m²). In an embodiment, the finished fabric weight is 5.0 oz/yd² (170 g/m²). Fabric weight is measured according to ASTM D 3776. In another embodiment, the first knitted portion is a double-knit fabric, pique knit or other weft knitted structure.

The machine used to form the first knitted portion, e.g., the single jersey fabric, is a Model 15 Mon 1680 NDL-84F-MEM circular knitting machine available from Monarch Knitting of England. Circular knitting machines of this type comprise a 30 inch knitting cylinder, uses 120 feeds, and is configured for 24-cut to form the single jersey embodiments. Twenty four cut refers to the number (24) of needles per inch and fabric so formed is known as a 24-cut fabric. Other “cuts” may used as need may arise.

In an embodiment, the first knitted portion is a weft knitted fabric formed from air-jet spun yarns. In this embodiment, the air jet spun yarns are formed from an intimate blend of modacrylic staple fibers and cotton fibers. The intimate blends have been found to have a soft hand that is comfortable to the wearer for extended periods, and for repeated use under conditions such as high temperature and high humidity.

Modacrylics are polymers that have between thirty-five percent and eighty-five percent acrylonitrile units, modified by other chemical modifiers such as vinyl chloride. All modacrylics have an inherently flame-resistant character to some extent; however, it has been found that fabrics formed from modacrylic yarns having at least about fifty percent by weight of acrylonitrile units will provide excellent flame resistance, even in the presence of non-flame resistant fibers. That is, they will not melt and drip, or continue to burn when a source of ignition is removed. One suitable modacrylic is a short staple fiber such as Kanecaron® Protex, manufactured by Kaneka Corporation, Osaka, Japan. These fibers have a tenacity of greater than about two grams/denier, and preferably about three grams/denier. In one embodiment, the staples are two inches in length and have a denier of about 1.5, however other fiber deniers are also within the scope of the invention. In addition to their good flame resistance, modacrylic fibers have a high degree of washability, meaning that soils or stains are more easily removed during laundering. Yarns formed exclusively of modacrylic fibers have inherent drawbacks. In particular, modacrylic yarns do not hold knitted stitches well. As a result, fabrics formed from these yarns alone often lack dimensional stability and durability to multiple launderings. When subjected to wear and laundering, the courses and wales of the fabric tend to stretch. Further, such fabrics have a pill resistance that is not adequate for high performance applications, such as military uses.

Cotton fibers are soft and moisture absorbent. These fibers have wide variability in fiber shape, fiber length and fiber diameter. Typically, shorter cotton fibers exhibit poor piling resistance in garments, and in some cases poor wash durability. Exemplary cotton fibers used to form the flame resistant undergarments herein are combed cotton fibers. This in part is due to the increased average fiber length combed fibers have over non-combed fibers. Further, different cotton types, such as Egyptian and Pima cotton, or cotton processes, such as mercerization, yield different values for yarn and fabric strength, pill resistance and wash durability. In an exemplary embodiment, Egyptian cotton, Pima cotton, or a blend of both is used. In other embodiments, mercerized cotton is used.

In general, the inventors have found that an intimate blend of modacrylic and cotton fibers may be used to form a lighter weight undergarment construction. The flame resistant yarns are air-jet spun from an intimate blend of at least about seventy-two percent modacrylic fibers and up to about twenty eight percent cotton fibers. Preferably, the modacrylic fibers comprise between about seventy-two (72) percent and about eighty (80) percent of the intimate blend. In addition, the cotton fibers preferably comprise between about twenty (20) percent and twenty-eight (28) percent of the intimate blend, more preferably a blend of 75/25 modacrylic/cotton. While a blend of only modacrylic and cotton is preferred, minor amounts of other fibers such as natural fibers like wool, other synthetic fibers such as rayon, or polymeric fibers like polyester, polyolefin, polyamide, polyamide 6,6, and aramid fibers and the like could be added. In an embodiment, the undergarments are formed with yarns having a linear density between about 30/1 cc and about 36/1 cc. In other exemplary embodiments, the linear density may vary outside of 30/1 cc and 36/1 cc. For example, the linear density of the yarn may be 28/1 cc, or even 40/1 cc. In other alternate embodiments, plied yarns may be used, such as two or three-ply yarns.

As described above and shown in FIGS. 1 and 2, the peripheral edges (22, 32, 42 and 122) of the undergarments include hems around the openings (20, 30, 40, and 120, respectively). The hems along the peripheral edges (22, 32, 42 and 122) of the openings (20, 30, 40, and 120, respectively) can be formed substantially of the first knitted portion or a second knitted portion. The peripheral edges 132 of waist opening 130, however, may have hem formed of the first knitted portion or the second knitted portion, and/or an elastic band, elastic fabric or other elastomeric material (not shown). The elastic band, fabric or other material gives the undergarment 100 a tight fit around the waist of a wearer. As described above, an exemplary hem is where the first knitted portion at the openings are turned, folded and seamed to form a smooth edge. In other embodiments, the hem can be formed with the second knitted portion. The second knitted portion may have any construction suitable to form a finished edge on an undergarment. Exemplary second knitted portion includes rib knit, single jersey, or double-knit constructions. In an embodiment, the second knit portion is also flame-resistant and is formed of an intimate blend of modacrylic and cotton fibers. However, the second knit portion may be formed without flame resistance, and of natural and synthetic fibers either alone, or any combination of cotton, wool, rayon, FR rayon, polyester, polyolefin, polyamide 6, polyamide 6,6, polylactic acid, modacrylic and aramids.

One or more chemical treatments, i.e. finishes, may be used to enhance the attributes of the undergarments. These treatments may be applied to the greige, or unfinished, fabric during dyeing and finishing. For example, various finishes may be added to the fabric during the jet dyeing, or other coloration process. In other embodiments, treatments may be applied post dyeing via pad application, spray coating or other surface application method.

In an embodiment, the undergarment includes a wicking agent to promote wicking of moisture outwardly away from the wearer. Preferably, the wicking agent is applied during jet dyeing. A wicking agent found to be effective at wicking moisture is ANWICK LW™, a proprietary product available from R.T. Anderson Enterprises of Raleigh, N.C. When ANWICK LW™ is applied to a fabric, the resulting fabric has a hydrophilic characteristic which allows for moisture transport away from the body, permitting evaporation while retaining the strength of the fibers comprising the fabric. Other wicking agents compatible with the yarns and apparel uses are also contemplated.

An anti-microbial treatment may be applied either during the dyeing process or by subsequent application onto the dyed fabric. An effective anti-microbial treatment is known as ATS ULTRA FRESH™ MVN-2, a 2,4,4′ tricholor-2′ hydroxydiphenyl ether, available from American Textile Specialties of Spartanburg, S.C. In another embodiment, about 0.75% by weight of Rucobac AGP, was applied to the fabrics. Rucobac AGP contains a soluble silver compound deposited on a synthetic oxide, and is available from Rudolf Chemicals Limited of Alfreton, Derbyshire, United Kingdom. Other anti-microbial agents may also be used that are compatible with the fibers and safe to use on undergarments.

Other agents, such as softeners, or hand modifiers may be used to improve the hand-profile of the undergarments described herein. Cationic, resin or silicone type softeners may be used. An exemplary softener is Apexosil 2130, a cationic softener, available from Apex Chemical, Inc.

Exemplary undergarments formed as described herein were formed with the fabrics described herein and subjected to numerous tests including: (1) Flame Resistance (Vertical Flame) (ASTM D 6413); (2) Pilling Resistance (Rando Tumble) (ASTM D 3512); (3) Dimensional Change After Home Laundering (5 Cycles) (AATCC 135); (4) Antibacterial Finish Assessment (AATCC 100); (5) Colorfastness and, and (6) Moisture Wicking Test. The moisture wicking test measures the length that water travels along a strip of fabric in three (3) minutes. The strip is cut to 2 in. by 9 in. and water is applied to one end of the strip. An acceptable level of wicking is when the water travels a length that is greater than or equal to 3 in. in 3 minutes.

The results of these tests are summarized in the tables below. This data shows that the unique combination of the fiber blend, yarn size, and chemical agents applied thereto yield flame resistant, durable, pill resistant undergarments. Further, tests have shown the flame resistance, pill resistance, dimensionally stability, colorfastness, antibacterial efficacy, wicking are maintained after twenty-five (25) home launderings conducted in accordance with AATCC 135. For example, when the undergarment is subjected to 25 launderings according to AATCC 135, the pill resistance value is about the same as the pill resistance of an unlaundered undergarment. This data shows that the undergarments are suitable for conditions such as high temperature and high humidity, for wear for extended periods, and for repeated uses.

TABLE 1
Flame Resistance (Vertical Flame) (ASTM D 6413)

| | Length | Width |
|---|---|---|
| After Flame (s) | 0 | 0 |
| After Glow (s) | 0 | 0 |
| Melting Drip (s) | 0 | 0 |
| Char Length (mm) | 115 | 119.2 |

TABLE 2
Physical Properties

| Property | Results |
|---|---|
| Fabric Weight (ASTM D3776) | 5.0 oz/yd² (170 g/m²) |
| Pilling Resistance (Rando Tumble) | 3.5-5.0 |
| (ASTM D 3512) | |
| Dimensional Change After Home Laundering | +4.2% |
| (5 Cycles) (AATCC 135)-Length | |
| Dimensional Change After Home Laundering | −2.7% |
| (5 Cycles) (AATCC 135)- Width | |
| Antibacterial Finish Assessment | 99.9* |
| (AATCC 100) 25 launderings | |
| Colorfastness to Crocking | 4.5 |
| (AATCC 8, Flat, Dry) | |
| Colorfastness to Crocking | 4.5 |
| (AATCC 8, Flat, Wet) | |
| Colorfastness to Light | 4.5 |
| (AATCC 16 Xenon, After 40 hours) | |
| Wicking | ≧3″ in 3 mins |

*Staphylococcus aureus, klebsiella pneumonia

Table 3 below shows colorfastness data for the flame resistant, durable, comfortable, pill resistant undergarment. The undergarments described herein where tested to assess colorfastness to laundering (AATCC 61-2A), acid and alkaline perspiration (AATCC 15). The flame resistant undergarments display acceptable colorfastness values (i.e., a value greater than a 4 on a scale of 1 to 5, as understood by a person of ordinary skill) for staining, and against other materials such as acetate, cotton, nylon, polyester, acrylic, and wool.

TABLE 3
Colorfastness

| | | Perspiration | Perspiration |
|---|---|---|---|
| | Laundering | (Acid) | (Alkaline) |
| | (AATCC 61-2A) | (AATCC 15) | (AATCC 15) |
| Staining | 4.5 | 4.5 | 4.5 |
| Acetate | 4.5 | 4.5 | 4.5 |
| Cotton | 4.5 | 4.5 | 4.5 |
| Nylon | 4.5 | 4.5 | 4.5 |
| Polyester | 4.5 | 4.5 | 4.5 |
| Acrylic | 4.5 | 4.5 | 4.5 |
| Wool | 4.5 | 4.5 | 4.5 |

Although the present invention has been described with exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

What is claimed is:

1. A flame resistant, durable, pill resistant upper body undergarment, comprising:
(a) an upper torso portion comprising a first knitted portion, a pair of arm openings having a peripheral edge and a neck opening having a peripheral edge;
(b) the first knitted portion having a weft knit structure formed from air-jet spun yarns, the air jet spun yarns comprising an intimate blend between 72 percent to 80 percent of modacrylic fibers and between 20 percent and 28 percent of cotton fibers, the plurality of air-jet yarns having a cotton count between 30/1 and 36/1;
(c) the peripheral edge of each arm opening and the neck opening formed into a hem; and
(d) the undergarment having a satisfactory flame resistance, durability and pill resistance for extended and repeated use under conditions such as high temperature and high humidity.

2. The undergarment of claim 1, the undergarment further comprising a wicking agent.

3. The undergarment of claim 1, the undergarment further comprising a softener.

4. The undergarment of claim 1, the undergarment further comprising an antimicrobial.

5. The undergarment of claim 1, wherein the first knitted portion has a pill resistance value between about 3.5 and 5 measured according to ASTM D 3512.

6. The undergarment of claim 1, wherein when the undergarment is subjected to 25 launderings according to AATCC 135, the pill resistance value is about the same as the pill resistance of an unlaundered undergarment.

7. The undergarment of claim 1, wherein the first knitted weft knit structure has a weight between about 4.0 oz/yd² and about 6.0 oz/yd².

8. The undergarment of claim 1, wherein the undergarment has a flame resistance indicated by a char length of less than about 120 mm.

9. The undergarment of claim 1, wherein the modacrylic fibers have a denier of 1.5.

10. The undergarment of claim 1, wherein the cotton fibers are combed cotton fibers.

11. The undergarment of claim 1, wherein the air-jet spun yarns have a linear density of 36/1.

12. The undergarment of claim 1, wherein the hem is formed from a second knitted portion formed from the group of constructions consisting of a rib-knit and single jersey construction.

13. The undergarment of claim 1, wherein the hem is formed from the first knitted portion that is turned and seamed.

14. A flame resistant, pill resistant, durable, lower body undergarment, the lower body undergarment comprising:
(a) a leg and lower torso portion comprising a first knitted portion, a waist opening and two leg openings, the waist opening having a peripheral edge and the leg openings having a peripheral edge;
(b) the first knitted portion having a weft knit structure formed from air-jet spun yarns, the air-jet spun yarns comprising an intimate blend between 72 percent to 80 percent of modacrylic fibers and between 20 percent and 28 percent of cotton fibers, the plurality of air-jet yarns having a cotton count between 30/1 and 36/1;
(c) the peripheral edge of the waist and leg openings formed into a hem; and
(d) the undergarment having a satisfactory flame resistance, durability and pill resistance for extended and repeated use under conditions such as high temperature and high humidity.

15. The undergarment of claim 14, the undergarment further comprising a wicking agent.

16. The undergarment of claim 14, the undergarment further comprising a softener.

17. The undergarment of claim 14, the undergarment further comprising an antimicrobial.

18. The undergarment of claim 14, wherein the first knitted portion has a pill resistance value between about 3.5 and 5 measured according to ASTM D 3512.

19. The undergarment of claim 14, wherein when the undergarment is subjected to 25 launderings according to AATCC 135, the pill resistance value is about the same as the pill resistance of an unlaundered undergarment.

20. The undergarment of claim 14, wherein the first knitted weft knit structure has a weight between about 4.0 oz/yd² and about 6.0 oz/yd².

21. The undergarment of claim 14, wherein the undergarment has a flame resistance indicated by a char length of less than about 120 mm.

22. The undergarment of claim 14, wherein the modacrylic fibers have a denier of 1.5.

23. The undergarment of claim 14, wherein the cotton fibers are combed cotton fibers.

24. The undergarment of claim 14, wherein the air-jet spun yarns have a linear density of 36/1.

25. The undergarment of claim 14, wherein the hem is formed from a second knitted portion formed from the group of constructions consisting of a rib-knit and single jersey construction.

26. The undergarment of claim 14, wherein the hem is formed from the first knitted portion that is turned and seamed.
